(19) United States
(12) Patent Application Publication
(10) Pub. No.: US 2010/0030931 A1
(43) Pub. Date: Feb. 4, 2010

(54) Scheduling proportional storage share for storage systems

(76) Inventor: Sridhar Balasubramanian, Wichita, KS (US)

Correspondence Address: LSI Corporation c/o Suiter Swantz pc llo, 14301 FNB Parkway, Suite 220, Omaha, NE, 68154, US

(21) Appl. No.: 12/221,515

(22) Filed: Aug. 4, 2008

(51) Int. Cl. G06F 3/00; G06F 13/00

(52) U.S. Cl. 710/39

(57) ABSTRACT

A system for scheduling proportional sharing of storage shares includes one or more hosts which are IO attached to storage system including a storage coordinator, a buffer, and one or more storage devices which are provided as one or more storage shares. A storage share scheduler of the storage coordinator propagates an IO request to the one or more storage devices when a ranking value tagged to the IO request is higher than and/or equal to that of other IO requests. The storage share scheduler stores an IO request in the buffer when the ranking value of the IO request is lower than that of at least one other IO request. The storage share scheduler schedules the IO request stored in the buffer to be propagated when the ranking value is higher than and/or equal to the ranking value of the other IO requests.

### TECHNICAL FIELD

The present disclosure generally relates to the field of storage systems, and more particularly to a system and method for scheduling proportional storage share for storage systems.

### BACKGROUND

A storage system may comprise an attached storage system such as a network-attached storage (NAS) system and/or a storage area network (SAN). A NAS system is a file-level computer data storage system connected to a computer network to provide data access to heterogeneous network clients. A SAN system attaches remote computer storage devices (such as disk arrays, tape libraries and optical jukeboxes) to hosts in such a way that, to the host, the devices appear as locally attached. A storage system may provide access to one or more physical storage devices (which may comprise one or more hard disk drives, one or more solid state drives, one or more optical drives, one or more RAIDs (redundant array of independent disks), one or more flash devices, and/or one or more tape drives), presented as one or more storage shares, to one or more IO (input/output) attached hosts. The storage system may receive one or more IO requests from the one or more IO attached hosts and propagate the one or more IO requests to the one or more physical storage devices.

### SUMMARY

A system for scheduling proportional sharing of storage shares may include one or more hosts which are IO attached to storage system. The storage system may include a storage coordinator, a buffer, and one or more storage devices which are provided to the one or more hosts as one or more storage shares. The storage coordinator may be attached to a fabric attachment if the storage system is equipped with fibre channel host-side connectivity. The storage coordinator may comprise an intelligent device that maintains a first-come-first served queue architecture for incoming IO requests and may be responsible for controlling broadcasted delay values for the IO requests. The ranking value of the IO requests may be broadcasted to all storage coordinating devices in order to delay one particular IO attached host's access in order to provide priority storage share access to another IO attached host based on a preset ranking value. The storage coordinator's delay broadcast approach may utilize distributed start-time fair queuing wherein a minimum amount of storage share for each IO attached host is guaranteed despite highly fluctuating incoming IO workloads.

The storage coordinator may proportionally share access to the storage shares among a plurality of IO requests received from the one or more hosts utilizing a storage scheduler. The storage coordinator may tag each of the plurality of IO requests with a ranking value. The storage coordinator may tag each of the plurality of IO requests with a ranking value of the host that generated the respective IO request. The storage share scheduler may propagate an IO request of the plurality of IO requests to the one or more storage devices when the ranking value of the IO request is higher than and/or equal to the ranking values of the other IO requests of the plurality of IO requests. The storage share scheduler may store an IO request of the plurality of IO requests in the buffer when the ranking value of the IO request is lower than the ranking values of at least one other IO requests of the plurality of IO requests. The storage share scheduler may schedule the IO request stored in the, buffer to be propagated to one or more of the storage devices when the ranking value of the stored IO request is higher than and/or equal to the ranking value of the other IO requests of the plurality of IO requests.

Each of the one or more hosts may be assigned a ranking value. The ranking value may be predetermined and assigned to each of the one or more hosts by a storage administrator. The ranking value may be assigned to each of the one or more hosts based on one or more of a type of application running on the host, a priority of an application running on the host, a mission-critical aspect of a storage share accessible by the host, at least one user group accessing a storage share accessible by the host, and/or a type of data stored on a storage share accessible by the host.

The proportional storage share scheduling approach of the present disclosure eliminates the resource contention condition that may occur in traditional storage systems when a multitude of hosts are attached to the storage system. This approach enables fine tuning of the proportion of storage share scheduling allocated to a host by allowing a user and/or system administrator to assign and/or alter the ranking of the host based on application type and/or priority aspects. The need for having expensive hardware implementation for processing the IO queues is eliminated. A minimum amount of service is guaranteed to every IO attached host. Even during fluctuating IO loads, this approach provides a fair amount of access to the storage shares to all IO attached hosts. Further, the proportional storage share scheduling approach of the present disclosure eliminates the possibility that a single host may monopolize a storage share, preventing other hosts from accessing the storage share.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram of a system for proportional sharing of storage shares, in accordance with an embodiment of the present disclosure;

FIG. 2 is a flow chart illustrating an example process of proportional storage sharing that may be implemented by the system illustrated in FIG. 1, in accordance with an embodiment of the present disclosure;

FIG. 3 is a diagram illustrating the operation of a storage share scheduler illustrated in FIG. 1, in accordance with an embodiment of the present disclosure; and

FIG. 4 is a flow diagram illustrating a method for scheduling proportional sharing of storage shares, in accordance with an embodiment of the present disclosure.

### DETAILED DESCRIPTION

Reference will now be made in detail to the subject matter disclosed, which is illustrated in the accompanying drawings.

A storage system may provide one or more storage shares to one or more IO (input/output) attached hosts. The storage system may receive one or more IO requests and propagate the one or more IO requests to the one or more storage shares and/or the one or more physical storage devices that the one or more storage shares represent. As the storage system may receive a plurality of IO requests from one or more IO attached hosts, the storage system may schedule the access of the plurality of IO requests to the one or more storage shares and/or the one or more physical storage devices that the one or more storage shares represent. Typical storage system scheduling algorithms are unable to handle multiple schedulers with multiple share resources. Scheduling performed at the physical storage device is unable to handle aggregated IO requests received by the initiator level. Broadcasting IO requests to physical storage devices may address accessibility issues across all physical storage devices, but may result in extreme overload conditions at the storage network layer.

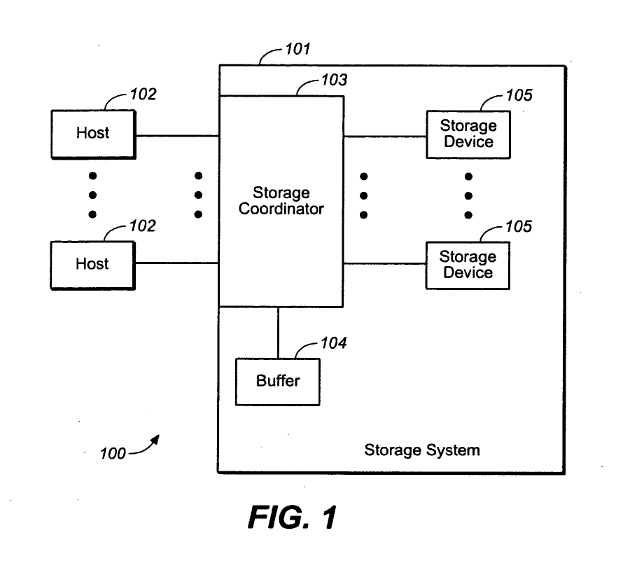

FIG. 1 illustrates a system 100 for scheduling proportional sharing of storage shares, in accordance with an embodiment of the present disclosure. The system 100 may include one or more hosts 102 which are IO attached to storage system 101. The storage system 101 may comprise an attached storage system such as a network-attached storage (NAS) system and/or a storage area network (SAN). The storage system 101 may include a storage coordinator 103, a buffer 104, and one or more storage devices 105 which are provided to the one or more hosts 102 as one or more storage shares. The storage devices 105 may comprise any kind of storage device including, but not limited to, one or more hard disk drives, one or more solid state drives, one or more optical drives, one or more RAIDs (redundant array of independent disks), one or more flash devices, and/or one or more tape drives. The storage coordinator 103 may be attached to a fabric attachment if the storage system 101 is equipped with fibre channel host-side connectivity. The storage coordinator 103 may comprise an intelligent device that maintains a first-come-first served queue architecture for incoming IO requests and may be responsible for controlling broadcasted delay values for the IO requests. The ranking value of the IO requests may be broadcasted to all storage coordinating devices in order to delay one particular IO attached host's access in order to provide priority storage share access to another IO attached host based on a preset ranking value. The storage coordinator's 103 delay broadcast approach may utilize distributed start-time fair queuing wherein a minimum amount of storage share for each IO attached host is guaranteed despite highly fluctuating incoming IO workloads.

The storage coordinator 103 may proportionally share access to the storage shares among a plurality of IO requests received from the one or more hosts 102 utilizing a storage scheduler. The storage coordinator 103 may tag each of the plurality of IO requests with a ranking value. The storage coordinator 103 may tag each of the plurality of IO requests with a ranking value of the host 102 that generated the respective IO request. The storage share scheduler may propagate an IO request of the plurality of IO requests to the one or more storage devices 105 when the ranking value of the IO request is higher than and/or equal to the ranking values of the other IO requests of the plurality of IO requests. The storage share scheduler may store an IO request of the plurality of IO requests in the buffer 104 when the ranking value of the IO request is lower than the ranking values of at least one other IO requests of the plurality of IO requests. The storage share scheduler may schedule the IO request stored in the buffer 104 to be propagated to one or more of the storage devices 105 when the ranking value of the stored IO request is higher than and/or equal to the ranking value of the other IO requests of the plurality of IO requests.

Each of the one or more hosts 102 may be assigned a ranking value. The ranking value may be predetermined and assigned to each of the one or more hosts 102 by a storage administrator. The ranking value may be assigned to each of the one or more hosts 102 based on a type of application running on the host 102. The ranking value may be assigned to each of the one or more hosts 102 based on a priority of an application running on the host 102. The ranking value may be assigned to each of the one or more hosts 102 based on a mission-critical aspect of a storage share accessible by the host 102. The ranking value may be assigned to each of the one or more hosts 102 based on at least one user group accessing a storage share accessible by the host 102. The ranking value may be assigned to each of the one or more hosts 102 based on a type of data stored on a storage share accessible by the host 102. The ranking value may be assigned to each of the one or more hosts 102 based on a combination of a type of application running on the host 102, a priority of an application running on the host 102, a mission-critical aspect of a storage share accessible by the host 102, at least one user group accessing a storage share accessible by the host 102, and/or a type of data stored on a storage share accessible by the host 102.

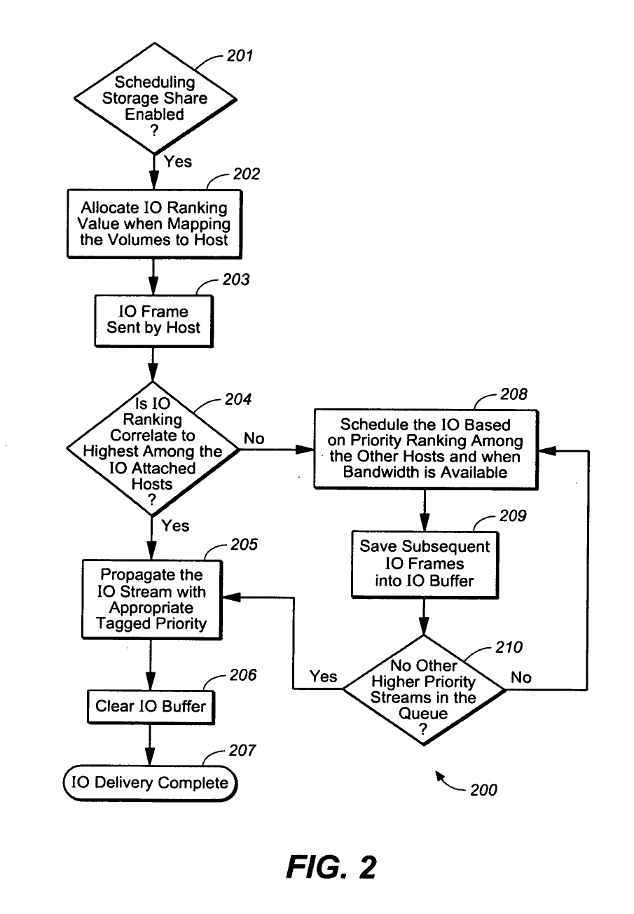

FIG. 2 is a flowchart illustrating an example process 200 of the storage coordinator 103 proportionally sharing access to the storage shares among a plurality of IO requests received from the one or more hosts 102, in accordance with an embodiment of the present disclosure. At 201, it is determined whether scheduling storage share is enabled. If scheduling storage share is enabled, allocate IO ranking value when mapping storage shares (or volumes) to hosts 202. When an IO frame has been sent by a host 203, determine whether the IO ranking of the IO frame is highest among all of the IO attached hosts that have sent IO frames 204. If the IO ranking of the IO frame is highest among all of the IO attached hosts that have sent IO frames 204, propagate the IO stream with appropriate tagged priority 205. Then, clear the IO buffer 206 and IO delivery 207 is complete. If the IO ranking of the IO frame is not highest among all of the IO attached hosts that have sent IO frames 204, schedule the IO based on priority ranking of the other hosts that have sent IO frames and when bandwidth is available 208. Then, save subsequent IO frames related to the IO frame into an IO buffer 209. Then, determine whether there are any other higher priority streams in the queue 210. If there are no higher priority streams in the queue 210, propagate the IO stream with appropriate tagged priority 205. If there are higher priority streams in the queue 210, schedule the IO based on priority ranking of the other hosts that have sent IO frames and when bandwidth is available 208.

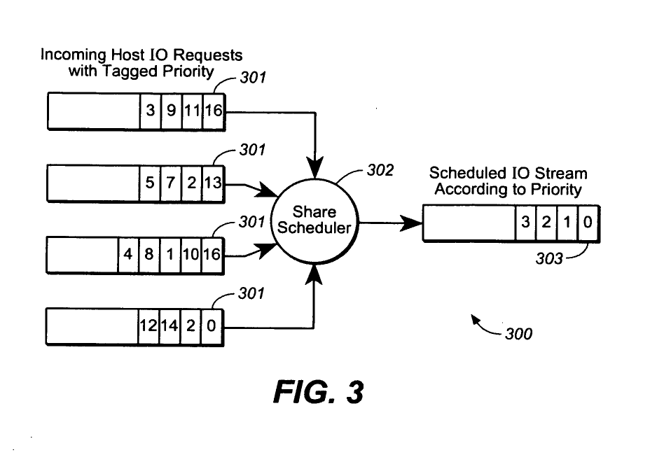

FIG. 3 illustrates the operation of the storage share scheduler, in accordance with an embodiment of the present disclosure. IO requests with tagged priority 301 are received by the share scheduler 302. The share scheduler propagates the IO requests as a scheduled IO stream according to priority 303.

The present disclosure is described below with reference to flowchart illustrations of methods. It will be understood that each block of the flowchart illustrations and/or combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart. These computer program instructions may also be stored in a computer-readable tangible medium (thus comprising a computer program product) that can direct a computer or other programmable data processing apparatus to function in a particular manner, such that the instructions stored in the computer-readable tangible medium produce an article of manufacture including instruction means which implement the function/act specified in the flowchart.

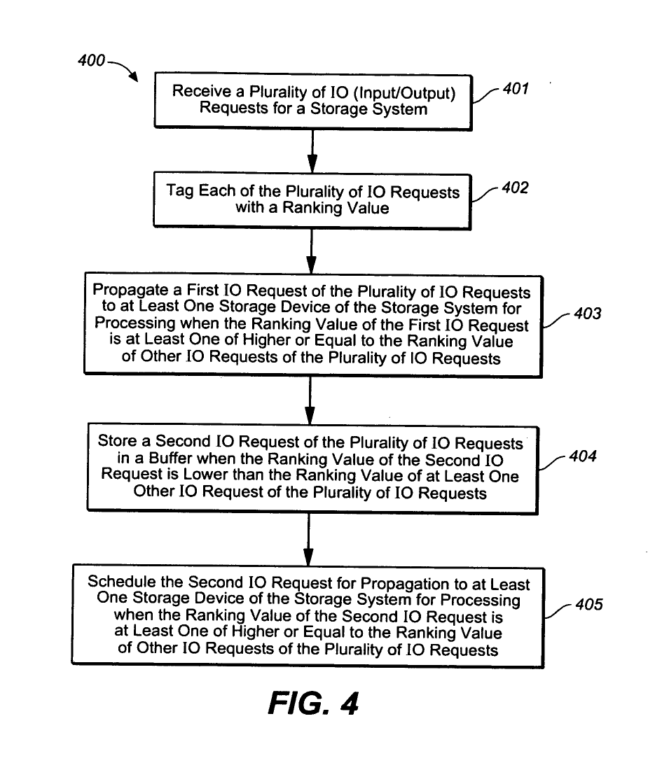

FIG. 4 illustrates a method of scheduling proportional sharing of storage shares, in accordance with an embodiment of the present disclosure. In step 401, receive a plurality of IO (input/output) requests for a storage system. In step 402, tag each of the plurality of IO requests with a ranking value. Each of the plurality of IO requests may be tagged with the ranking value of a host of the plurality of hosts that generated the respective IO request. The ranking value of the host may be based on a type of application running on the host. The ranking value of the host may be based on a priority of an application running on the host. The ranking value of the host may be based on a mission-critical aspect of a storage share accessible by the host. The ranking value of the host may be based on at least one user group accessing a storage share accessible by the host. The ranking value of the host may be based on a type of data stored on a storage share accessible by the host. The ranking value of the host may be based on a combination of a type of application running on the host, a priority of an application running on the host, a mission-critical aspect of a storage share accessible by the host, at least one user group accessing a storage share accessible by the host, and/or a type of data stored on a storage share accessible by the host. In step 403, propagate a first IO request of the plurality of IO requests to at least one storage device of the storage system for processing when the ranking value of the first IO request is at least one of higher or equal to the ranking value of other IO requests of the plurality of IO requests. In step 404, store a second IO request of the plurality of IO requests in a buffer when the ranking value of the second IO request is lower than the ranking value of at least one other IO request of the plurality of IO requests. In step 405, schedule the second IO request for propagation to at least one storage device of the storage system for processing when the ranking value of the second IO request is at least one of higher or equal to the ranking value of other IO requests of the plurality of IO requests.

The proportional storage share scheduling approach of the present disclosure eliminates the resource contention condition that may occur in traditional storage systems when a multitude of hosts are attached to the storage system. This approach enables fine tuning of the proportion of storage share scheduling allocated to a host by allowing a user and/or system administrator to assign and/or alter the ranking of the host based on application type and/or priority aspects. The need for having expensive hardware implementation for processing the IO queues is eliminated. A minimum amount of service is guaranteed to every IO attached host. Even during fluctuating IO loads, this approach provides a fair amount of access to the storage shares to all IO attached hosts. Further, the proportional storage share scheduling approach of the present disclosure eliminates the possibility that a single host may monopolize a storage share, preventing other hosts from accessing the storage share.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method, comprising:
receiving a plurality of IO (input/output) requests for a storage system;
tagging each of the plurality of IO requests with a ranking value;
propagating a first IO request of the plurality of IO requests to at least one storage device of the storage system for processing when the ranking value of the first IO request is at least one of higher or equal to the ranking value of other IO requests of the plurality of IO requests;
storing a second IO request of the plurality of IO requests in a buffer when the ranking value of the second IO request is lower than the ranking value of at least one other IO request of the plurality of IO requests; and
scheduling the second IO request for propagation to at least one storage device of the storage system for processing when the ranking value of the second IO request is at least one of higher or equal to the ranking value of other IO requests of the plurality of IO requests.

2. The method of claim 1, wherein said tagging each of the plurality of IO requests with the ranking value comprises:
tagging each of the plurality of IO requests with the ranking value of an IO attached host that generated the respective IO request.

3. The method of claim 3, wherein the ranking value of the IO attached host is based on a type of application running on the IO attached host.

4. The method of claim 3, wherein the ranking value of the IO attached host is based on a priority of an application running the IO attached host.

5. The method of claim 3, wherein the ranking value of the IO attached host is based on a mission-critical aspect of a storage share accessible by the IO attached host.

6. The method of claim 3, wherein the ranking value of the IO attached host is based on at least one user group accessing a storage share accessible by the IO attached host.

7. The method of claim 3, wherein the ranking value of the IO attached host is based on a type of data stored on a storage share accessible by the IO attached host.

8. A system, comprising:
a plurality of hosts;
a storage system, communicatively coupled to the plurality of hosts, comprising:
at least one storage device;
a buffer; and
a storage share coordinator that receives a plurality IO (input/output) requests from the plurality of hosts, tags each of the plurality of IO requests with a ranking value, and propagates the IO requests to the at least one storage device utilizing a storage share scheduler,
wherein the storage share scheduler propagates an IO request of the plurality of IO requests when the ranking value of the IO request is at least one of higher or equal to the ranking value of other IO requests of the plurality of IO requests, the storage share scheduler stores the IO request of the plurality of IO requests in the buffer when the ranking value of the IO request is lower than the ranking value of at least one other IO request of the plurality of IO requests, and the storage share scheduler schedules the IO request stored in the buffer for propagation when the ranking value of the stored IO request is at least one of higher or equal to the ranking value of other IO requests in the plurality of IO requests.

9. The system of claim 8, wherein the storage share coordinator tags each of the plurality of IO requests with the ranking value of a host of the plurality of hosts that generated the respective IO request.

10. The system of claim 9, wherein the ranking value of the host is based on a type of application running on the host.

11. The system of claim 9, wherein the ranking value of the host is based on a priority of an application running on the host.

12. The system of claim 9, wherein the ranking value of the host is based on a mission-critical aspect of a storage share accessible by the host.

13. The system of claim 9, wherein the ranking value of the host is based on at least one user group accessing a storage share accessible by the host.

14. The system of claim 9, wherein the ranking value of the host is based on a type of data stored on a storage share accessible by the host.

15. A computer program product for scheduling proportional storage share, the computer program product comprising:
a tangible computer usable medium having computer usable code tangibly embodied therewith, the computer usable program code comprising:
computer usable program code configured to receive a plurality of IO (input/output) requests for a storage system;
computer usable program code configured to tag each of the plurality of IO requests with a ranking value;
computer usable program code configured to propagate a first IO request of the plurality of IO requests to at least one storage device of the storage system for processing when the ranking value of the first IO request is at least one of higher or equal to the ranking value of other IO requests of the plurality of IO requests;
computer usable program code configured to store a second IO request of the plurality of IO requests in a buffer when the ranking value of the second IO request is lower than the ranking value of at least one other IO request of the plurality of IO requests; and
computer usable program code configured to schedule the second IO request for propagation to at least one storage device of the storage system for processing when the ranking value of the second IO request is at least one of higher or equal to the ranking value of other IO requests of the plurality of IO requests.

16. The computer program product of claim 15, wherein said computer usable program code configured to tag each of the plurality of IO requests with a ranking value comprises
computer usable program code configured to tag each of the plurality of IO requests with the ranking value of an IO attached host that generated the respective IO request.

17. The computer program product of claim 16, wherein the ranking value of the IO attached host is based on a type of application running on the IO attached host.

18. The computer program product of claim 16, wherein the ranking value of the IO attached host is based on a priority of an application running the IO attached host.

19. The computer program product of claim 16, wherein the ranking value of the IO attached host is based on a mission-critical aspect of a storage share accessible by the IO attached host.

20. The computer program product of claim 16, wherein the ranking value of the IO attached host is based on at least one user group accessing a storage share accessible by the IO attached host.

21. The computer program product of claim 16, wherein the ranking value of the IO attached host is based on a type of data stored on a storage share accessible by the IO attached host.
